(19) United States
(12) Patent Application Publication
(10) Pub. No.: US 2024/0430554 A1
(43) Pub. Date: Dec. 26, 2024

(54) DEVICE FOR ANALYSIS AND RECORDING OF AN IMAGE, ESPECIALLY IN AN EXPLOSION HAZARD ZONE

(71) Applicant: INTEGROTECH SP. Z O.O., Lódz (PL)

(72) Inventors: Piotr Luczak, Lódz (PL); Grzegorz Niklewicz, Bibice (PL); Rafal Zagawa, Lódz (PL)

(21) Appl. No.: 18/740,250

(22) Filed: Jun. 11, 2024

(30) Foreign Application Priority Data
Jun. 22, 2023 (PL) P.445323

(51) Int. Cl. H04N 23/50; G03B 15/03; H04N 23/51; H04N 23/52; H04N 23/54; H04N 23/55; H04N 23/56; H04N 25/20; H04N 25/76

(52) U.S. Cl. CPC H04N 23/555; G03B 15/03; H04N 23/51; H04N 23/52; H04N 23/54; H04N 23/55; H04N 23/56; H04N 25/20; H04N 25/76; G03B 2215/0503; G03B 2215/0567

(57) ABSTRACT

A device for image analysis and recording, in particular in an explosion hazard zone, designed for observing, for example, gas meter counters, converting the observed image and transmitting alphanumeric characters converted to discrete form as recorded in the field of view of the camera. The device has inside an aluminum two-part housing of Ex design for explosion hazard zones separate miniaturized infrared light source modules, a CMOS matrix with a microcontroller (22), a single-module SOM-type computer, a power supply circuit, communication and power ports characterized in that it has lenses (25) tightly adhering to the infrared light-emitting diodes (24) and to the glass (2) of the top of the housing (1). These are symmetrically arranged in two lines, intersecting the CMOS sensor with the microcontroller (22) and the lens (23).

### CROSS REFERENCE TO RELATED APPLICATIONS

The present patent application is a U.S. national application filed under 35 U.S.C. 111(a), which claims priority to Polish Application P. 445323, filed on Jun. 22, 2023, the content of which is incorporated in this patent application by reference in its entirety for all purposes.

### FIELD OF THE INVENTION

The invention relates to a device for image analysis and recording, in particular in an explosion hazard zone, designed for observing, for example, gas meter counters, converting the observed image and transmitting alphanumeric characters converted to discrete form as recorded in the field of view of the camera.

### BACKGROUND

The known measuring devices available on the market are equipped with cameras that can be mounted in explosion hazard zones. An example of such a solution is the XF40-Q1765 device from the Swedish company AXIS, built in the form of an enclosed cylindrical housing with one side finished with a transparent glass, designed for operation in an explosion hazard zone. The device does not have a built-in computer, but only allows data to be sent to monitor the facility.

From the Polish patent description 232609 a device is known for analyzing and recording images in particular in an explosion hazard zone. Inside an aluminum two-part housing, the device has lenses tightly adhering to the infrared light-emitting diodes and to the glass of the upper part of the housing, and they are symmetrically arranged in one line with the CMOS matrix with a microcontroller and the lens. The lens is terminated by an O-ring which adheres to the glass of the upper housing. A photoresistor is placed between the CMOS matrix with the microcontroller and the infrared light-emitting diodes. The circuits of the CMOS matrix with the microcontroller of the infrared light-emitting diodes and the photoresistor are placed on a separate printed circuit, fixed on spacer screws to the other printed circuit boards. The CMOS matrix with the microcontroller is located on a thermally conductive tape adjacent to the printed circuit board. The thermally conductive tape is placed between the bottom of the housing and the third board.

### SUMMARY

The device for image analysis and recording, in particular in an explosion hazard zone, according to the invention has inside the aluminum two-part housing of Ex design for explosion hazard zones separate miniaturized infrared light source modules, a CMOS matrix with a microcontroller, a single-module SOM-type computer, a power supply circuit, communication and power ports. It is characterized by having lenses tightly adhering to the infrared light-emitting diodes and to the glass of the top of the housing. These are symmetrically arranged in two lines, intersecting the CMOS sensor with the microcontroller and the lens, and the lens is terminated by an O-ring that adheres to the glass of the upper housing. A photoresistor is placed between the CMOS matrix with the microcontroller and the infrared light-emitting diodes. The circuits of the CMOS matrix with the microcontroller of the infrared light-emitting diodes and the photoresistor are placed on a separate printed circuit mounted with screws to a heatsink to which a second printed circuit is also screwed from the bottom. The CMOS matrix with the microcontroller adheres to the printed circuit, while the thermal conductive tape is placed between the lower part of the housing and the third board.

The solution according to the invention allows the data provided by the CMOS matrix microcontroller to be quickly analyzed in such a way that the image to be analyzed is converted into a character string identical to that represented on the gas meter counter. In character form, it is then transmitted via an RS232/485 serial interface or Ethernet interface to higher-level, master control systems, thus acting as a diagnostic device in the explosion hazard zone.

The device can be powered by 24V DV and by Power over Ethernet (PoE).

Due to the compact design of the device, i.e. the placement of the vision elements (CMOS matrix with the microcontroller and lens) and the illumination elements, it can be used in areas where space is limited to a single explosion-proof device body.

### BRIEF DESCRIPTION OF THE DRAWING

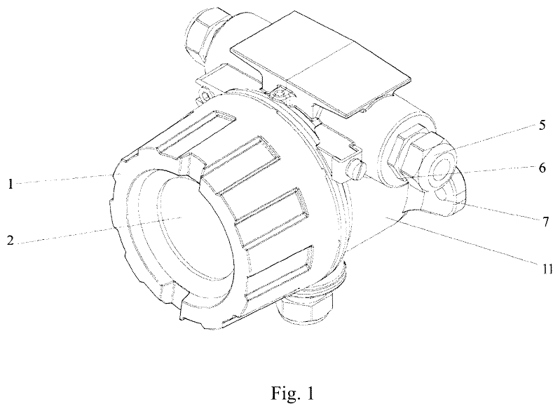

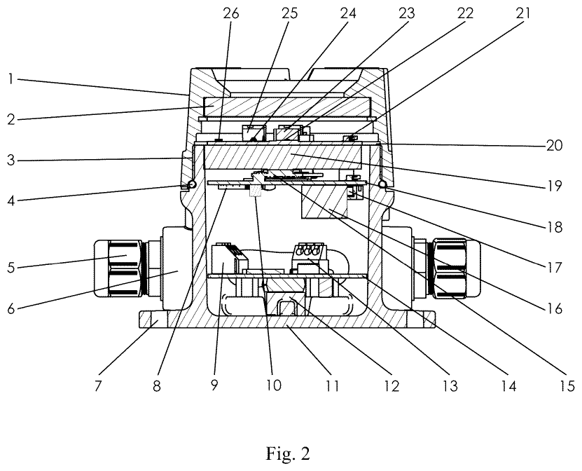

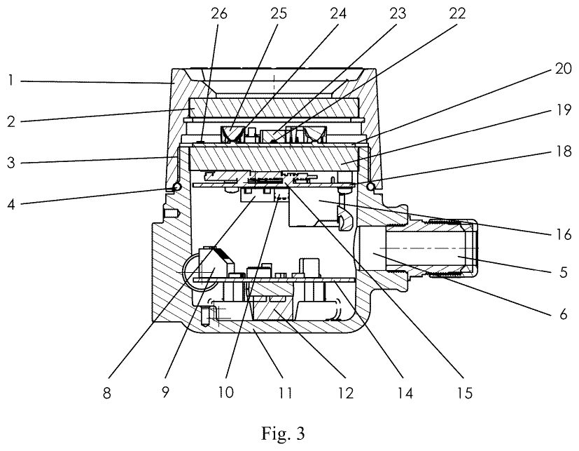

A device for image analysis and recording, in particular in an explosion hazard zone, is shown in the embodiment and drawing in which FIG. 1 shows the device in perspective view, FIG. 2—main cross-section, and FIG. 3—another cross-section.

### DETAILED DESCRIPTION OF THE PREFERRED EMBODIMENTS

The device comprises three boards fitted with electronic components 14, 18, 20.

The first board 20 is equipped with a CMOS matrix with a microcontroller 22 and lens 23, and next to it there is a photoresistor 21, four infrared light-emitting diodes 24 with built-in lenses 25. On the second board 18 there is mounted an RJ45 port 16, a port for an external memory card 8, a single-module SOM-type computer 15, a connector for the battery 10 used for maintaining memory time and device time and a power supply 17. On the third board 14 are fitted the ports used for the power supply 13, the ports used for data transmission 9 (2×RS232/485). A thermally conductive tape 12 is placed between the third board 14 and the lower part of the housing 11. The first board 20 and the second board 18 are connected by four screws (each) 26 screwed into a heatsink 19 which passively dissipates heat from the single-module SOM-type computer 15. The whole is set in a housing 1, 11 suitable for use in an explosion hazard zone. The housing comprises two parts that connect to each other by means of a threaded connection 3. In addition, it is sealed with an O-ring 4. The upper part of the housing 1 cylindrical in shape is equipped with a glass pane 2 which covers the recording module. The lower part of the housing 11, also cylindrical in shape, has three holes 6 into which are screwed cable grommets 5 used for the necessary cabling—power supply, RS232/485 transmission signals and Ethernet cable. In additional, at the base, the housing has two flat brackets with through holes 7.

These are used to attach the camera to an external mount.

1. A device for image analysis and recording, in particular in an explosion hazard zone, having inside an aluminum two-part housing of Ex design for explosion hazard zones separate miniaturized infrared light source modules, a CMOS matrix with a microcontroller, a single-module SOM-type computer, a power supply circuit, communication and power ports, characterized in that it has lenses (25) tightly adhering to the infrared light-emitting diodes (24) and to the glass (2) of the upper part of the housing (1), and they are symmetrically arranged in one line with the CMOS matrix with the microcontroller (22) and the lens (23) and the lens is terminated by an O-ring (4) that adheres to the glass (2) of the upper housing (1), while a photoresistor (21) is placed between the CMOS matrix with the microcontroller (22) and the infrared light-emitting diodes (24), and the circuits of the CMOS matrix with the microcontroller (22) of the infrared light-emitting diodes (24) and the photoresistor (21) are placed on a separate printed circuit (20) mounted with screws (26) to a heatsink (17), to which a second printed circuit (18) is also screwed from the bottom. The CMOS matrix with the microcontroller (22) adheres to the printed circuit (20), while the thermal conductive tape (12) is placed between the lower part of the housing (11) and the third board (14).
